(19) United States
(12) Patent Application Publication
(10) Pub. No.: US 2021/0201384 A1
(43) Pub. Date: Jul. 1, 2021

(54) REGION ARRANGEMENT METHODS, APPARATUSES AND STORAGE MEDIA

(71) Applicant: Beijing Sensetime Technology Development Co., Ltd., Beijing (CN)

(72) Inventors: Xuecheng WANG, Beijing (CN); Lingfeng PAN, Beijing (CN)

(21) Appl. No.: 17/083,417

(22) Filed: Oct. 29, 2020

Related U.S. Application Data
(63) Continuation of application No. PCT/CN2020/103131, filed on Jul. 20, 2020.

(30) Foreign Application Priority Data
Dec. 25, 2019 (CN) 201911360720.8

(51) Int. Cl. G06Q 30/06; G06K 9/00; G07C 9/00

(52) U.S. Cl. CPC G06Q 30/0639; G06K 9/00771; G07C 2009/00365; G07C 9/00309; G06K 9/0063

(57) ABSTRACT

Examples of the present disclosure provide a region arrangement method, apparatus and storage medium, wherein the region arrangement method includes: respectively acquiring association degree data between a first region and each of a plurality of second regions, wherein the first region and the plurality of second regions are located in a first site; obtaining a region arrangement analysis result by analyzing, according to the association degree data, arrangement between the first region and the plurality of second regions in the first site; and based on the region arrangement analysis result, performing region arrangement on a second site or outputting region arrangement information of the second site.

### CROSS-REFERENCE TO RELATED APPLICATION

The present disclosure is a continuation of International Application No. PCT/CN2020/103131, filed on Jul. 20, 2020, which claims priority of Chinese patent application No. 201911360720.8 filed on Dec. 25, 2019, the entire content of which are incorporated herein by reference.

### TECHNICAL FIELD

The present disclosure relates to the field of computer vision technology, in particular to a region arrangement method, apparatus and storage medium.

### BACKGROUND

There are many different types of shops in shopping sites such as large shopping malls and supermarkets. The layout of shops will affect the shopping experience of customers and store entry rate and sales. For a new shopping mall that is about to open, when stores in the new shopping mall are determined, it is often necessary for the staff to count the needs of the stores and the rent they can bear, and then to deploy or arrange the stores in the new shopping mall in combination with the statistical data. For a larger shopping mall, collecting data, performing statistics and analysis on the data and so on for the staff will consume a lot of manpower and material resources.

### SUMMARY

The present disclosure examples provide technical solutions for a region arrangement method.

In the first aspect, examples of the present disclosure provide a region arrangement method, which includes: respectively acquiring association degree data between a first region and each of a plurality of second regions, wherein the first region and the plurality of second regions are located in a first site; obtaining a region arrangement analysis result by analyzing, according to the association degree data, arrangement between the first region and the plurality of second regions in the first site; and based on the region arrangement analysis result, performing region arrangement on a second site or outputting region arrangement information of the second site.

In some examples of the present disclosure, respectively acquiring association degree data between the first region and each of the plurality of second regions includes: acquiring a plurality of video images of the first site within a predetermined time range; performing pedestrian identification processing on the plurality of video images to obtain, based on the identification result, a customer counting result for each of the first region and the plurality of second regions; and determining, based on customer counting results, association degree data between the first region and each of the plurality of second regions, respectively.

In some examples of the present disclosure, the region arrangement analysis result includes ranking of the association degree data. Performing region arrangement on the second site based on the region arrangement analysis result includes: arranging at least part of the plurality of second regions on two sides of the first region according to the ranking of the association degree data and a position of the first region in the second site. For each of the at least part of the plurality of second regions, a distance between the second region after arrangement and the first region is positively correlated with an association degree between the second region and the first region.

In some examples of the present disclosure, in a case that the first site and the second site are of a same type, the first region includes an entrance and exit region, and the plurality of second regions include store regions. Or, in a case that the first site and the second site are of different types, the first region includes an entrance and exit region, and the plurality of second regions include store regions, or the first region and the plurality of second regions include store regions.

In some examples of the present disclosure, after performing region arrangement on the second site, the method further includes: acquiring association degree data between two adjacent regions after arrangement; and determining an arrangement position of a temporary booth according to types of the two adjacent regions and the association degree data between the two adjacent regions.

In some examples of the present disclosure, in a case that the first site and the second site are of the same type, the first site includes a plurality of first regions, and the plurality of first regions include entrance and exit regions, for each of the plurality of first regions, the region arrangement analysis result includes a sum of association degree data between the first region and each of the plurality of second regions. Performing region arrangement on the second site based on the region arrangement analysis result includes: according to ranking of sums of association degree data, determining to open at least part of entrances and exits in the plurality of first regions, and close entrances and exits other than the at least part of entrances and exits in the plurality of first regions. The sum of the association degree data for the first region corresponding to an opened entrance and exit is greater than or equal to the sum of the association degree data for the first region corresponding to a closed entrance and exit.

In some examples of the present disclosure, the region arrangement analysis result includes target association degree data in which association degree data is greater than a predetermined threshold. The method further includes: placing at least part of commodities sold in the second region corresponding to the target association degree data in the first region for sale; and/or placing a commodity with the same type as the at least part of the commodities in the first region for sale; and/or pushing promotion data of the second region corresponding to the target association degree data through a promotion device deployed in the first region.

In the second aspect, examples of the present disclosure provide a region arrangement apparatus, which includes:

an acquisition module configured to respectively acquire association degree data between a first region and each of a plurality of second regions, wherein the first region and the plurality of second regions are located in a first site;

an analyzing module configured to obtain a region arrangement analysis result by analyzing, according to the association degree data, arrangement between the first region and the plurality of second regions in the first site; and

an arrangement module configured to: perform region arrangement on a second site based on the region arrangement analysis result or output region arrangement information of the second site based on the region arrangement analysis result.

In some examples of the present disclosure, the acquisition module is configured to: acquire a plurality of video images of the first site within a predetermined time range; perform pedestrian identification processing on the plurality of video images to obtain, based on the identification result, a customer counting result for each of the first region and the plurality of second regions; and determine, based on customer counting results, association degree data between the first region and each of the plurality of second regions, respectively.

In some examples of the present disclosure, the region arrangement analysis result includes ranking of the association degree data. The arrangement module is configured to: arrange at least part of the plurality of second regions on two sides of the first region according to the ranking of the association degree data and a position of the first region in the second site. For each of the at least part of the plurality of second regions, a distance between the second region after arrangement and the first region is positively correlated with an association degree between the second region and the first region.

In some examples of the present disclosure, in a case that the first site and the second site are of a same type, the first region includes an entrance and exit region, and the plurality of second regions include store regions. Or, in a case that the first site and the second site are of different types, the first region includes an entrance and exit region, and the plurality of second regions include store regions, or the first region and the plurality of second regions include store regions.

In some examples of the present disclosure, the arrangement module is further configured to: after performing region arrangement on the second site, acquire association degree data between two adjacent regions after arrangement; and determine an arrangement position of a temporary booth according to types of the two adjacent regions and the association degree data between the two adjacent regions.

In some examples of the present disclosure, in a case that the first site and the second site are of the same type, the first site includes a plurality of first regions, and the plurality of first regions include entrance and exit regions, for each of the plurality of first regions, the region arrangement analysis result includes a sum of association degree data between the first region and each of the plurality of second regions. The arrangement module is configured to: according to ranking of sums of association degree data, determine to open at least part of entrances and exits in the plurality of first regions, and close entrances and exits other than the at least part of entrances and exits in the plurality of first regions. The sum of the association degree data for the first region corresponding to an opened entrance and exit is greater than or equal to the sum of the association degree data for the first region corresponding to a closed entrance and exit.

In some examples of the present disclosure, the region arrangement analysis result includes target association degree data in which association degree data is greater than a predetermined threshold. The apparatus further includes: a promotion module configured to place at least part of commodities sold in the second region corresponding to the target association degree data in the first region for sale; and/or place a commodity with the same type as the at least part of the commodities sold in the second region corresponding to the target association degree data in the first region for sale; and/or push promotion data of the second region corresponding to the target association degree data through a promotion device deployed in the first region.

In the third aspect, examples of the present disclosure provide a region arrangement apparatus, which includes: a memory, a processor, and a computer program stored on the memory and executable on the processor; wherein when the computer program is executed by the processor, the steps of the region arrangement method according to examples of the present disclosure are implemented.

In the fourth aspect, examples of the present disclosure provide computer storage medium storing a computer program, when the computer program is executed by a processor, the processor is caused to perform the region arrangement method according to examples of the present disclosure.

In the fifth aspect, examples of the present disclosure further provide a computer program, wherein the computer program causes a computer to perform the region arrangement method according to examples of the present disclosure.

In the technical solutions provided in examples of the present disclosure, association degree data between a first region and each of a plurality of second regions is respectively acquired, where the first region and the plurality of second regions are located at a first site; arrangement between the first region and the plurality of second regions in the first site is analyzed according to the association degree data to obtain a region arrangement analysis result; and based on the region arrangement analysis result, region arrangement is performed on a second site or region arrangement information of the second site is output. In this way, a reasonable layout of the first region and the second regions in the second site can be made or the region arrangement information for the region arrangement of the second site can be automatically given based on the association degree data between the first region and each of the plurality of second regions in the first site, thereby saving manpower and material resources consumed by the staff to perform data collection, data statistics and analysis. Moreover, in the process of arranging each region in the second site or providing region arrangement information for the region arrangement of the second site with the above implementations, the association degree data between multiple regions can be taken into account, thereby increasing the number of customers and sales revenue.

### BRIEF DESCRIPTION OF THE DRAWINGS

FIG. 1 is a schematic flowchart of a region arrangement method provided by examples of the present disclosure.

FIG. 2 is a schematic diagram of ranking of region association degree between a first region and each second region in the first site provided by examples of the present disclosure.

FIG. 3 is a schematic diagram of a layout of a second site provided by examples of the present disclosure.

FIG. 4 is a schematic flowchart for a process of determining region association degree provided by examples of the present disclosure.

FIG. 5 schematic diagram of a structure of a region arrangement apparatus provided by examples of the present disclosure.

FIG. 6 is a schematic diagram of a hardware structure of a region arrangement apparatus provided by examples of the present disclosure.

### DETAILED DESCRIPTION OF THE EMBODIMENTS

To make a person skilled in the art better understand technical solutions provided by the embodiments of the present disclosure, the technical solutions in the embodiments of the present disclosure will be clearly described below with reference to the accompanying drawings in the embodiments of the present disclosure. Apparently, the embodiments described are merely some embodiments of the present disclosure, and not all embodiments.

The terms “first,” “second,” and “third,” etc. in the description embodiments and claims of the present disclosure and the above drawings are used to distinguish similar objects, and are not used to describe a particular order or sequence. Moreover, the terms “comprising/including” and “having” and any variation thereof, are intended to cover non-exclusive inclusion, e. g., the inclusion of a series of steps or units. The method, system, product or device are not limited to those steps or units that are explicitly listed, but may include other steps or units that are not explicitly listed or that are inherent to the process, method, product or device.

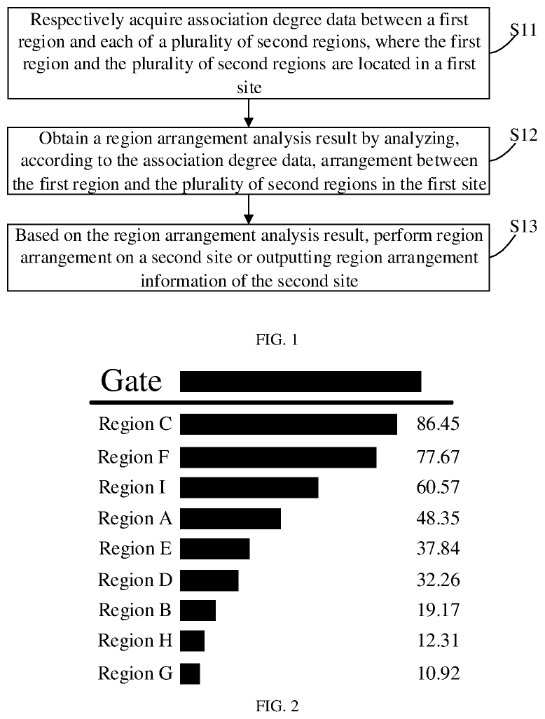

Examples of the present disclosure provide a region arrangement method, which can be applied to a variety of electronic devices, including, but not limited to, fixed devices and/or mobile devices. For example, the fixed device includes, but not limited to: a personal computer (Personal Computer, PC), or a server, etc. The server may include a cloud server or a normal server. The mobile devices include, but not limited to, one or more of a mobile phone, a tablet or a wearable device. As shown in FIG. 1, the method includes the following steps S11-S13.

At step S11, association degree data between a first region and each of a plurality of second regions is respectively acquired, where the first region and the plurality of second regions are located at a first site.

At step S12, arrangement between the first region and the plurality of second regions in the first site is analyzed according to the association degree data to obtain a region arrangement analysis result.

At step S13, based on the region arrangement analysis result, region arrangement is performed on a second site or region arrangement information of the second site is output.

In examples of the present disclosure, the first site generally refers to a place at which commodities can be displayed or sold, and includes, but not limited to, shopping malls or supermarkets. Similarly, the second site generally refers to a place at which commodities can be displayed or sold, and includes, but not limited to, supermarkets or shopping malls. Of course, the first site and the second site in examples of the present disclosure may also be other types of public sites, which are not limited in examples.

In examples of the present disclosure, the first site may include a plurality of regions, and the first region and the second regions may be any two types of regions in a plurality of regions included in the first site. In an implementation, the first region may include one region and the second regions may include multiple regions. It should be noted that the number of regions included in the first region and the number of regions included in the second regions are not limited here and may include, but not limited to, the cases mentioned above.

To sufficiently use the association degree data to realize the arrangement of each region in the second site, generally, the sum of the number of regions included in the first region and the number of regions included in the second regions is at least three. The first region may generally refer to a region at which the gate or entrance and exit of the first site is located, or a region, such as a shop or a store, at which the first commodity is displayed and sold. The second regions are any one or more regions other than the first region in the first site. For example, the second regions may include a region at which the gate or entrance and exit of the first site is located, or a region, such as a shop or a store, at which a second commodity is displayed and sold.

For example, the first region is a target region of a user, the second regions are other regions set by the user except the target region; or, the first region and the second regions are different regions of the same store. The division of the regions may be set by the user according to demand. The user may be understood as the manager of the target site, such as the first site. Examples of the present disclosure do not limit the size, position and corresponding division of sites such as the first site, as well as regions such as the first region, the second region, etc.

In examples of the present disclosure, taking the first region including one and the second regions including multiple as an example, the region arrangement analysis result may be obtained by analyzing, according to the association degree data between the first region and the plurality of e second regions in the first site, arrangement between the first region and the plurality of second regions in the first site. In an example, the region arrangement analysis result includes the ranking result for the association degree data between the first region and plurality of second regions. In another example, the region arrangement analysis result includes a summary of the association degree between the first region and the plurality of second regions. The summary of the association degree may include, for example, which regions have higher association degree, which regions have lower association degree, and so on. In still another example, the region arrangement analysis result may further include the arrangement effect analysis result between the first region and the plurality of second regions. The arrangement effect analysis result may include, for example, which regions are arranged more suitable or unsuitable together, layout improvement recommendation, etc. The layout improvement recommendation may include, for example, adjusting the positions of which regions. It should be noted that the region arrangement analysis result may include, but not limited to, the above examples, and may include a combination of one or more of the above examples.

In examples of the present disclosure, the second site and the first site may be of the same type or of different types.

In some examples, in the case of the first site and the second site being the same type of site, the technical solutions provided by examples of the present disclosure are to adjust the arrangement position of each region in an arranged site. Taking the type of the site being a shopping mall as an example, a position such as an entrance and exit of the shopping mall is already fixed and cannot be changed. The first region may include an entrance and exit region, and the second regions may include stores or the like, in this case, the arrangement position of each second region may be adjusted by improving the arrangement manner of the adjustable stores. For example, the arrangement positions of several stores are exchanged. Similarly, taking the type of the site being shop or store as an example, a position such as an entrance and exit is already fixed. The first region may include an entrance and exit region of the shop or store, and the second regions may include shelfs of various products displayed in the shop, in this case, the arrangement position of each region in the site is adjusted by adjusting the layout within the shop or the store.

In this way, when the type of the first site is the same as that of the second site, the first region can represent a region at which the arrangement position is difficult to adjust or at which the arrangement position is fixed. Accordingly, the second regions can represent regions at which the arrangement position is easy to adjust or not fixed.

In the case that the type of the first site is different from that of the second site, the technical solutions provided by examples of the present disclosure are to reasonably arrange the arrangement positions of each region in the unarranged second site. Reference can be made to the arrangement of each region in the first site, as well as the association degree data, so that after the arrangement of each region in the second site, two or more regions with high association degree can be arranged as close as possible to facilitate customers to continuously access to the two or more regions. Or two or more regions with low association degree can be arranged as close as possible so that customers have to pass through one or more regions to reach the other or multiple regions they are trying to access. The specific arrangement mode can be adjusted according to different requirements and includes but not limited to the two cases mentioned above. For example, the above two cases can be considered in combination, and the reasonable arrangement can be performed by balancing the two cases.

In an example, in the case that the type of the first site is different from that of the second site, the first region may include an entrance and exit region, the second regions may include store regions. Or, the first region and the second regions may both include stores. That is, since the second site is a new undeployed site different from the first site, in an implementation, a position such as an entrance and exit may still not be determined, and thus the first region and the second regions are less restricted. In this case, a core region of position arrangement may be determined as the first region and non-core regions may be determined as the second regions. The first region is used as the arrangement center. The arrangement of the second site is completed by arranging the second regions.

It should be noted that in examples of the present disclosure, the second site and the first site may be of the same type. When the second site and the first site are of the same type, arranging the position of each region in the second site based on the region arrangement analysis result refers to adjusting the region position of each region in the first site (or the second site) based on the region arrangement analysis result for the first region. When the second site and the first site are of different types, arranging the position of each region in the second site based on the region arrangement analysis result refers to adjusting the position of each region in the second site based on the region arrangement analysis result for the first region.

In examples of the present disclosure, outputting the region arrangement information of the second site based on the region arrangement analysis result represents outputting arrangement proposals for each region in the second site based on the region arrangement analysis result for the first region. Thus, the operator of the second site can refer to the region arrangement information to deploy or arrange stores in the second site.

In some alternative examples, the region arrangement information can be displayed in text and/or graphical form. For example, the region arrangement information in text form may include rough arrangement position or specific arrangement position of each region of the second site in the second site. For example, in a case that the initial layout of each region in the second site has been determined, the region arrangement information may include the specific positions of the regions in which some stores are located in the second site, where the specific positions of the regions in which the stores are located may be identified through an identifier of each region in the initial layout of the second site. Or, in the case that some regions (such as gates, entrances and exits or stores) are fixedly arranged in the second site, the region arrangement information may include relative position information of regions in which some stores are located in the second site. The relative position information includes, for example, a layout proposal away from the gate or entrance and exit (or near the gate or entrance and exit). Exemplary, region arrangement information in the graphical form can represent the rough arrangement position or specific arrangement position of each region of the second site in the second site by intuitive graphics. For example, in a case that the initial layout of each region in the second site has been determined, the region arrangement information in the graphical form may include a layout map of each region of the second site. Of course, the region arrangement information output in examples can be displayed in a combination of the above text and graphical forms.

In the technical solution provided by examples of the present disclosure, association degree data between a first region and each of a plurality of second regions is respectively acquired, where the first region and the plurality of second regions are located at a first site; arrangement between the first region and the plurality of second regions in the first site is analyzed according to the association degree data to obtain a region arrangement analysis result; and based on the region arrangement analysis result, region arrangement is performed on a second site or region arrangement information of the second site is output. In this way, a reasonable layout of the first region and the second regions in the second site can be made or the region arrangement information for the region arrangement of the second site can be automatically given based on the association degree data between the first region and each of the plurality of second regions in the first site, thereby saving manpower and material resources consumed by the staff to perform data collection, data statistics and analysis. Moreover, in the process of arranging each region in the second site or providing region arrangement information for the region arrangement of the second site with the above implementations, the association degree data between multiple regions can be taken into account, thereby increasing the number of customers and sales revenue.

In some alternative examples of the present disclosure, to obtain association degree data that can reflect the association degree between regions, step 101 may include sub-steps 1011-1013.

At sub-step 1011, a plurality of video images of the first site within a predetermined time range are acquired.

At sub-step 1012, pedestrian identification processing is performed on the plurality of video images to obtain, based on the identification result, a customer counting result for each of the first region and the plurality of second regions.

At sub-step 1013, association degree data between the first region and each of the plurality of second regions is respectively determined based on customer counting results.

In examples of the present disclosure, the predetermined time range may include a period of time, such as a day, a week, a month, a quarter of a year, a half year, a year, etc., starting with a start time and ending with an end time, which may be determined on the basis of actual requirements. The examples of the present disclosure do not limit the configuration method and specific value of the preset time range. It should be noted that the end time is a time before the current time, that is, the end time cannot be later than the current time.

In examples of the present disclosure, the video images are captured by an image acquisition device (such as a camera or an image capture machine) installed in each region of the first site.

In examples of the present disclosure, the video images can be obtained in multiple ways. For example, the video images transmitted by the image acquisition device can be received, or the video images transmitted by other devices can be received by a communicator, and the video images transmitted by other devices may be captured by the image acquisition device.

In an alternative implementation of the present disclosure, performing pedestrian identification processing on the plurality of video images to obtain, based on the identification result, the customer counting result for the first region includes: obtaining a plurality of first images of the first region included in the plurality of video images; for each of the plurality of first images, performing human face tracking and/or human body tracking on the first image to obtain a human face tracking result and/or human body tracking result for the first image, obtaining a pedestrian identification result for the first image based on the human face tracking result and/or human body tracking result for the first image; and obtaining the customer counting result for the first region based on the pedestrian identification result for each of the plurality of first images of the first region. Similarly, performing pedestrian identification processing on the plurality of video images to obtain, based on the identification result, the customer counting result for the second region includes: obtaining a plurality of first images of the second region included in the plurality of video images; for each of the plurality of first images, performing human face tracking and/or human body tracking on the first image to obtain a human face tracking result and/or human body tracking result for the first image, obtaining a pedestrian identification result for the first image based on the human face tracking result and/or human body tracking result for the first image; and obtaining the customer counting result for the second region based on the pedestrian identification result for each of the plurality of first images of the second region.

In some examples, pedestrian detection can be performed on the image to obtain at least one pedestrian bounding box in the image; and for each pedestrian bounding box, human face tracking and/or human body tracking is performed based on the pedestrian bounding box to obtain a human face tracking result and/or a human body tracking result; and a pedestrian identification result is obtained based on one of the human face tracking result and/or the human body tracking result.

In this way, compared with customer counting by manually observing real pedestrians (walkers) through naked eyes, in the present disclosure, customer counting is completed by performing human body identification and/or human face identification on acquired pedestrian images, and a large number of images can be processed in a relatively short time, thereby improving statistics efficiency and saving human resources.

In the examples, the image may be subjected to image identification processing by any human face identification technology to obtain a human face feature identification result for the image. The examples of the present disclosure do not specifically define the human face identification technology.

In the examples, the image may be subjected to image identification processing by any human body identification technology to obtain a human body feature identification result for the image. The examples of the present disclosure do not specifically define the human body identification technology.

In some alternative examples of the present disclosure, obtaining the pedestrian identification result for the first image based on the human face tracking result and/or human body tracking result for the first image includes: in response to a human body image corresponding to the human body tracking result satisfying a predetermined condition, obtaining the pedestrian identification result based on human body image information corresponding to the human body tracking result; and/or, in response to the human body image corresponding to the human body tracking result not satisfying the predetermined condition, obtaining the pedestrian identification result based on human face image information corresponding to the human face tracking result.

The human face image information includes feature information of the human face image and/or the human face image. The human body image information includes feature information of the human body image and/or the human body image.

In some alternative examples, the predetermined condition may include: the quality of the human body image satisfies the predetermined quality requirement, for example, the predetermined quality requirement includes any one or more of the human face clarity satisfying the predetermined clarity requirement, the human face size satisfying the predetermined size requirement, the human face angle satisfying the predetermined angle requirement, the human face detection confidence (i.e., degree of confidence) satisfying the predetermined confidence requirement, the human body detection confidence satisfying the predetermined confidence requirement, or the human face integrity satisfying the predetermined human face integrity requirement.

In this way, when performing pedestrian identification, the human body identification result is analyzed first. If the human body identification result cannot be identified, then the human face identification result is analyzed. Since human body identification is easier and has shorter time-consumption than the human face identification, and the pedestrian identification result is obtained by combining the human body identification and the human face identification, misidentification due to factors such as human face angle or occlusion can be avoided, and identification efficiency can be improved, thereby improving customer counting efficiency.

In some alternative examples of the present disclosure, obtaining the pedestrian identification result based on human body image information corresponding to the human body tracking result includes: determining whether a human body template matching the human body image information exists in a human body template database; in response to determining that the matched human body template exists in the human body template database, using a pedestrian identifier corresponding to the matched human body template as the pedestrian identification result; and/or, in response to determining that the matched human body template does not exist in the human body template database, using a newly added pedestrian identifier as the pedestrian identification result.

In some examples, a similarity between a human body feature of an image and a reference human body feature included in at least one human body template stored in the human body template database may be determined, and it is determined whether a human body template matching the image exists in the human body template database based on whether the similarity is greater than or equal to a predetermined threshold exists. However, the examples of the present disclosure are not limited thereto. For example, if the human body template database includes a human body template, and the similarity between the reference human body feature included in the human body template and the human body feature of the image is greater than or equal to the predetermined threshold, it may be determined that the human body template matching the image exists in the human body template database. On the contrary, if for each of human body templates in the human body template database, the similarity between the reference human body feature included in the human body template and the human body feature of the image is less than the predetermined threshold, it may be determined that the human body template matching the image does not exist in the human body template database.

In the examples, a plurality of human body templates may be stored in the human body template database, each human body template includes the corresponding reference human body feature and the corresponding pedestrian identifier. The pedestrian identifier may be used to represent a pedestrian corresponding to the reference human feature (or the human body template). In an example, a pedestrian identifier may be configured for each human body template in the human body template database, the pedestrian identifier may be a serial number, and the serial number may uniquely identify a corresponding human body template in the human body template database.

In some alternative examples of the present disclosure, the method further includes: in response to determining that the matched human body template exists in the human body template database, determining a human body identifier corresponding to the matched human body template; and using a pedestrian identifier corresponding to the human body identifier in an association database as the pedestrian identifier corresponding to the matched human body template. The associated database is used to store an association relationship between a predetermined human body identifier and a predetermined human identifier (i.e., pedestrian identifier).

In this way, the pedestrian identifier corresponding to the human body template can be supplemented by using the association relationship stored in the association database, and thus the analysis and refinement of the pedestrian can be improved.

In some alternative examples of the present disclosure, the method further includes: in response to determining that the matched human body template does not exist in the human body template database, adding a human body template corresponding to the human body image information to the human body template database.

In the examples, if the matched human body template does not exist in the human body template database, the human body template corresponding to the human body image information may be added to the human body template database. In an example, the human body feature corresponding to the human body image information may be taken as a human body template, the human body template may be added to the human body template database, and a new pedestrian identifier can be assigned to the added human body template.

In this way, if the matched human body template does not exist in the human body template database, the human body template corresponding to the human body image information is added to the human body template database, and thus data can be supplemented to the human body template database. When the customer accesses again, subsequent query is facilitated.

In some alternative examples of the present disclosure, obtaining the pedestrian identification result based on human face image information corresponding to the human face tracking result includes: determining whether a human face template matching the human face image information exists in a human face template database; in response to determining that the matched human face template exists in the human face template database, using a pedestrian identifier corresponding to the matched human face template as the pedestrian identification result; and/or, in response to determining that the matched human face template does not exist in the human face template database, using a newly added pedestrian identifier as the pedestrian identification result.

In some examples, a similarity between a human face feature of an image and a reference human face feature included in at least one human face template stored in the human face template database may be determined, and it is determined whether a human face template matching the image exists in the human face template database based on whether the similarity is greater than or equal to a predetermined threshold exists. However, the examples of the present disclosure are not limited thereto. For example, if the human face template database includes a human face template, and the similarity between the reference human face feature included in the human face template and the human face feature of the image is greater than or equal to the predetermined threshold, it may be determined that the human face template matching the image exists in the human face template database. On the contrary, if for each of human face templates in the human face template database, the similarity between the reference human face feature included in the human face template and the human face feature of the image is less than the predetermined threshold, it may be determined that the human face template matching the image does not exist in the human face template database.

In the examples, multiple human face templates can be stored in the human face template database. Each human face template includes the corresponding reference human face feature and the corresponding pedestrian identifier. The pedestrian identifier may be used to represent a pedestrian corresponding to the reference human face feature (or the human face template). In an example, a pedestrian identifier may be configured for each human face template in the human face template database. The pedestrian identifier may be a serial number, which can uniquely identify a corresponding human face template in the human face template database.

In some alternative examples of the present disclosure, the method further includes: in response to determining that the matched human face template does not exist in the human face template database, adding a human face template corresponding to the human face image information to the human face template database.

In the examples, if the matched human face template does not exist in the human face template database, the human face template corresponding to the human face image information may be added to the human face template database. In an example, the human face feature corresponding to the human face image information may be taken as a human face template, the human face template may be added to the human face template database, and a new pedestrian identifier can be assigned to the added human face template.

In this way, if the matched human face template does not exist in the human face template database, the human face template corresponding to the human face image information is added to the human face template database, and thus data can be supplemented to the human face template database. When the customer accesses again, subsequent query is facilitated.

In some alternative examples of the present disclosure, the association degree between the first region and the second region may be determined with the following formula:

$$the associaton degree between region A and region B = \frac{\begin{matrix}the number of customer s who have been \\ to both region A and region B\end{matrix}}{the number of customers who have been to region B} \times 100 \% \qquad ( 1 )$$

In some alternative examples of the present disclosure, the association degree between the first region and the second region may be determined with the following formula:

$$the associaton degree between region A and region B = \frac{\begin{matrix}the number of customer s who have been \\ to both region A and region B\end{matrix}}{the number of customers who have been to region A} \times 100 \% \qquad ( 2 )$$

Examples of the present disclosure does not mandatorily define the calculation formula of the association degree. It should be noted that, when determining the association degree between the first region and the second region, several bits after the decimal point may be reserved. Regarding the specific bits after the decimal point, the configuration or adjustment may be performed according to the precision requirements.

In this way, compared with by users manually recording or inferring the association degree between regions, in the present disclosure, by automatically identifying pedestrians to determine customer counting results, the association degree is determined based on the customer counting results. It is convenient, saves the time and effort of the persons, and facilitates the users to perform targeted work and service based on the analysis result for the association degree, thereby improving customer experience and sale conversion rate.

The undeployed/unarranged sites can be reasonably planned in combination with the deployed analysis results of other sites. The region arrangement analysis results include the ranking of the association degree data. In an implementation, performing region arrangement on the second site based on the region arrangement analysis result includes: arranging at least part of the plurality of second regions on two sides of the first region according to the ranking of the association degree data and a position of the first region in the second site. For each of the at least part of the plurality of second regions, a distance between the second region after arrangement and the first region is positively correlated with an association degree between the second region and the first region.

In other alternative examples, the output region arrangement information of the second site may include the arrangement manner of the first region and at least part of second regions in multiple second regions represented by the text form and/or graphical form.

In some alternative examples, arranging at least part of the plurality of second regions on two sides of the first region according to the ranking of the association degree data and a position of the first region in the second site includes: by taking the position of the first region as a center, according to a distance between the position of the first region and each of to-be-arranged positions, arranging at least part of the plurality of second regions in the to-be-arranged positions. For a to-be-arranged position with a shorter distance from the position of the first region, the greater the association degree between the arranged second region in the to-be-arranged position and the first region.

For example, the first site includes the first region S0 and 4 second regions S1, S2, S3, and S4, and the ranking result for the association degree data between the 4 second regions and the first region S0 is S1>S2>S3>S4. The second site includes the first region S0 and 4 to-be-arranged second regions, the 4 to-be-arranged second regions are around the first region, and the distances between the first region and the 4 to-be-arranged second regions are L1, L2, L3, and L4, respectively. L1<L2<L3<L4. In a to-be-arranged position with the distance L1 from the first region, the second region S1 is arranged. In a to-be-arranged position with the distance L2 from the first region, the second region S2 is arranged. In a to-be-arranged position with the distance L3 from the first region, the second region S3 is arranged. In a to-be-arranged position with the distance L4 from the first region, the second region S4 is arranged.

In practical applications, for the uneven layout of stores or for the scene of the display of commodities in the store, the first region can be understood as a core region and the second regions are arranged according to the respective distance from the first region. The closer the second region is to the first region, the larger the association degree between the second region and the first region is.

In some alternative examples, arranging at least part of the plurality of second regions on two sides of the first region according to the ranking of the association degree data and a position of the first region in the second site includes: according to the association degree data, arranging a region having a high association degree with the first region near the first region. The association degree data refers to data reflecting a level of the association degree, for example, the association degree data between the first region and the second region can reflect the level of the association degree between the first region and the second region. Usually, the association degree data is equivalent to the association degree, or the association degree data may represent the association degree, which is not limited here.

For example, the first site includes a first region and M second regions, and the second regions near or around the first region in the second site are arranged based on association degree data between M region pairs, where the M is a positive integer greater than or equal to 1. Suppose that the first region and N second regions are included in the second site, an association degree ranking result for the N second regions and the first region in the second site is determined according to a ranking result for the association degree data between M region pairs in the first site. The second regions in the second site are thus arranged around the first region in the second site according to the association degree ranking result, where the N is a positive integer greater than or equal to 1, and N is less than or equal to M. In an example, the second region having a high association degree with the first region is arranged near the first region. The second region having a low association degree with the first region is arranged far away from the first region.

FIG. 2 is a schematic diagram of ranking of region association degree between a first region and a second region in the first site. Taking the first region being a gate region and the second regions being store regions as an example, 8 second regions are respectively marked as region A, region B, region C, region D, region E, region F, region G, region H, and region I. As can be seen from FIG. 2, the association degrees between the first region and regions C, F, I, A, E, D, B, H and G are decreased successively.

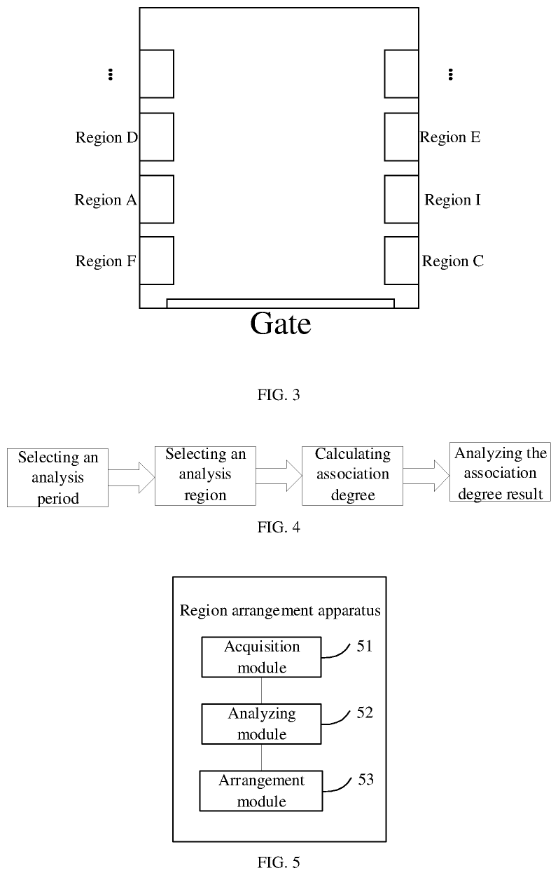

According to the diagram of association degree ranking shown in FIG. 2, FIG. 3 shows schematic diagram of a layout of the second site. As shown in FIG. 3, eight second regions are arranged around the first region according to the ranking result. The greater the association degree between the second region and the first region, the closer the distance between the second region and the first region. In some examples, arranging at least part of the plurality of second regions on two sides of the first region according to the ranking of the association degree data and a position of the first region in the second site includes: according to the association degree data, two second regions with the top-2 association degrees are arranged next to the first region, then the association degree between other second regions except the two second regions and the two second regions is re-determined with reference to the two second regions on two sides of the first region, and then two of the other second regions having top-2 association degrees with the two second regions are respectively arranged on the other side of the two second regions.

For example, the first site includes the first region S0 and four second regions S1, S2, S3, and S4, and the association degree ranking result between the four second regions and the first region S0 is S1>S2>S3>S4. If the second site includes the first region S0 and the four second regions S1, S2, S3, and S4, the second regions S1 and S2 are respectively arranged on two sides of the first region S0. If the ranking result for the association degree between the second regions S3 and S4 and the second region S1 is S3>S4, then the second region S3 is laid out or arranged on the other side of the second region S1. If the ranking result for the association degree between the second regions S3 and S4 and the second region S2 is S4>S3, then the second region S4 is laid out or arranged on the other side of the second region S2.

Thus, for undeployed situations, after the position of the first region (such as the gate region) is determined and two stores have been arranged around the first region (such as the gate region), in subsequent arrangement, not only the association degree with the first region needs to be considered, but also the association degree with two arranged stores is considered. Based on the association degree data between each region in the first site, a reasonable layout is performed on the regions in the second site. Thus, the number of customers and sales revenue can be increased.

In view of sufficiently utilizing site resources to increase revenue of a target site, in an implementation, after performing region arrangement on the second site based on the region deployment analysis result, the method further includes: acquiring association degree data between two adjacent regions after arrangement; and determining an arrangement position of a temporary booth according to types of the two adjacent regions and the association degree data between the two adjacent regions.

In some alternative examples, the output region arrangement information may include the arrangement position of the above temporary booth represented by text and/or graphical form. In examples of the present disclosure, the temporary booth may include a vending machine, a prize exchange office, etc.

In an example, when the first region and the second region are stores, according to the association degree between stores, a bid is called for a position between the two stores at which the vending machine can be placed. The higher the association degree between the two scores, the higher the rent of the position between the two stores. In this way, a bid is called for the vending machine according to the association degree between stores, the higher the association degree between the two scores, the higher the rent of the position between the two stores, and thus the revenue of the shopping mall can be increased.

In an example, the rent of the temporary booth between the two stores can be determined with reference to the following formula:

Rent=R+K* the association degree data between left and right two regions; the R represents a reference rent, the K represents a coefficient, and the left and right two regions represent two regions located in the left side and right side of the temporary booth.

Specifically, assuming R=4000 and K=50, if the association degree data between two regions located in the left side and right side of the temporary booth is 90.84, the rent for the temporary booth=4000+50*90.84=8542.

Of course, the above rent calculation formula is only an example. The rent calculation formula can be changed combined with association degree between regions according to the actual demand.

Thus, by determining the position of the temporary booth, the site resources can be fully utilized, thereby facilitating to increase the revenue of the site.

In view of that the position of the gate or entrance and exit of the site can affect the number of customers, in an implementation, the position of each region in the second site can be arranged based on the analysis results. That is, in some examples, in a case that the first site and the second site are of the same type, the first site includes a plurality of first regions, and the plurality of first regions include entrance and exit regions, for each of the plurality of first regions, the region arrangement analysis result includes a sum of association degree data between the first region and each of the plurality of second regions. Performing region arrangement on the second site based on the region arrangement analysis result includes: according to ranking of the sums of association degree data, determining to open at least part of entrances and exits in the plurality of first regions, and close entrances and exits other than the at least part of entrances and exits in the plurality of first regions. The sum of the association degree data for the first region corresponding to an opened entrance and exit is greater than or equal to the sum of the association degree data for the first region corresponding to a closed entrance and exit.

In other alternative examples, the output region arrangement information of the second site may include proposals regarding the opening or closing of the entrance and exit in text and/or graphical form.

In some examples, the sum of the association degree data refers to the sum of the association degree data between each second region and the first region.

For example, the first site includes four first regions (for example, a gate region), which are respectively marked as M1, M2, M3 and M4, and ten second regions such as stores S1, S2, S3, S4, S5, S6, S7, S8, S9 and S10. The sum of the association degree data of the ten stores with the gate region M1 is W1. The sum of the association degree data of the ten stores with the gate region M2 is W2. The sum of the association degree data of the ten stores with the gate region M3 is W3. The sum of the association degree data of the ten stores with the gate region M4 is W4. Where W1>W2>W3>W4. If one gate is to be closed, the gate M4 is to be closed. If two gates are to be closed, the gates M4 and M3 are to be closed. If the three gates are to be closed, the gates M4, M3 and M2 are to be closed.

In this way, when there are more than one gate in the site, it is sometimes necessary to close one or more of the gates to facilitate the management or save human resources. By reasonably selecting the gate to be closed, human resources can be saved without affecting the number of customers.

In view of mutual benefit and win-win, in an implementation, the product in the second region may be sold in the first region to increase the number of customers or sale volume. That is, in some examples, the region arrangement analysis result includes target association degree data in which association degree data is greater than a predetermined threshold. The method further includes: placing at least part of commodities sold in the second region corresponding to the target association degree data in the first region for sale; and/or, placing a commodity with the same type as the at least part of the commodities in the first region for sale; and/or, pushing promotion data of the second region corresponding to the target association degree data through a promotion device deployed in the first region.

In examples of the present disclosure, the predetermined threshold can be determined according to the actual situation.

In examples of the present disclosure, the promotion data includes advertising push, such as promotion information, newly-increased content, etc.

In examples of the present disclosure, the promotion device includes, but not limited to, a device such as an advertising screen or a speaker for voice playback.

In an example, a second region with the highest association degree with the first region is determined. The first commodity in the second region with the highest association degree with the first region is promoted on the display screen within the first region. In this way, by placing commodities on display screens or promotional panels within merchandising regions of other stores for promotion to increase sale volume.

For example, for a movie theater, considering that a person who enters the movie theater often performs consumption in a drinking store, the movie theater can play a drinking advertisement about the drinking store, thereby realizing mutual benefit.

In an example, a second region with the highest association degree with the first region is determined. A first commodity in the second region with the highest association degree with the first region is placed into a shelf of the first region. In this way, a commodity of a merchant with the highest association degree with a region owned by a certain merchant may be added to the shelf of the certain merchant for sale, so as to realize mutual benefit and win-win.

For example, for a movie theater, considering that a person who enters the movie theater often performs consumption in a drinking store, a product with a good sale volume in the drinking store can be put into the movie theater for sale, so as to realize mutual benefit and win-win.

In this way, for a merchant, based on the region association degree result, the types of the commodities in the store can be increased and the commodities for sale can also be personalized according to the region association degree result between different regions, thereby increasing the number of customers and sale revenue to the merchant.

In some examples, the methods described above may be performed by a server. The server can be a cloud server and/or a front-end server. For example, the above method is implemented by a front-end server (such as a video integrated machine) and a cloud server. The front-end server performs human face tracking and human body tracking on the acquired image to obtain the human face tracking result and the human body tracking result; determines which image information to perform pedestrian identification based on the quality of human face image and/or human body image; and then sends the determined image information to the cloud server. After receiving the image information sent by the front-end server, the cloud server queries a corresponding database based on the received image information, obtains a pedestrian identification result, and sends a corresponding processing result, such as association degree data between region pairs, arrangement solution, and so on, to the terminal device. The examples of the present disclosure do not limit thereto.

FIG. 4 shows a schematic flowchart for a process of determining region association degree. As shown in FIG. 4. The process includes: selecting an analysis period, selecting an analysis region, calculating association degree, and analyzing the association degree result.

In some examples, selecting an analysis period includes: selecting a time range (i.e., the above predetermined time range) for calculating the association degree. The minimum time length is one day, or any period of time is selected before the day.

In some examples, selecting an analysis region includes: selecting regions that wants to calculate the association degree, and dividing and defining the regions.

For example, visiting/accessing store A refers to entering store A and resides in store A for more than X minutes. Visiting/accessing a large screen of the shopping mall refers to facing the large screen beyond Y seconds within a determined range in front of the large screen. In this way, the accuracy of the region division can be improved compared with the region roughly determined by the naked eyes.

In some examples, calculating association degree includes: calculating association degree with following formulas:

if the time range is one day,

$$the associaton degree between region A and designated region B = \frac{\begin{matrix}the number of customer s who have been \\ to both region A and region B\end{matrix}}{the number of customers who have been to region B} \times 100 \% ;$$

and
if the time range exceeds one day,

$$the associaton degree between region A and designated region B = \frac{\begin{matrix}the number of cumulative customers who have been \\ to both region A and region B\end{matrix}}{the number of customers who have been to region B} \times 100 \% .$$

In some examples, the above association degree may reserve two bits after a decimal point (such as 85.38%).

In some examples, analyzing the association degree result includes: after calculating the association degrees between all regions, for a designated region, the association degree result for other regions to the designated region is ranked in a descending order; and analyzing which two regions have a high association degree to perform further analysis and layout.

It should be understood that the process of determining the association degree shown in FIG. 4 is an alternative detailed implementation, but not limited to this.

It should also be understood that the process of determining the association degree shown in FIG. 4 is merely for illustrating the examples of the present disclosure, and various obvious changes and/or replacements can be made by those skilled in the art based on the example shown in FIG. 4, and the obtained technical solution still belongs to the disclosed scope of the examples of the present disclosure.

Corresponding to the above region arrangement methods, examples of the present disclosure provide a region arrangement apparatus. As shown in FIG. 5, the apparatus includes an acquisition module 51, an analyzing module 52 and an arrangement module 53.

The acquisition module 51 is configured to respectively acquire association degree data between a first region and each of a plurality of second regions, wherein the first region and the plurality of second regions are located in a first site.

The analyzing module 52 is configured to obtain a region arrangement analysis result by analyzing, according to the association degree data, arrangement between the first region and the plurality of second regions in the first site.

The arrangement module 53 is configured to: perform region arrangement on a second site based on the region arrangement analysis result or output region arrangement information of the second site based on the region arrangement analysis result.

In some examples, the acquisition module 51 is configured to: acquire a plurality of video images of the first site within a predetermined time range; perform pedestrian identification processing on the plurality of video images to obtain, based on the identification result, a customer counting result for each of the first region and the plurality of second regions; and determine, based on customer counting results, association degree data between the first region and each of the plurality of second regions, respectively.

In some examples, the region arrangement analysis result includes ranking of the association degree data. The arrangement module 53 is configured to: arrange at least part of the plurality of second regions on two sides of the first region according to the ranking of the association degree data and a position of the first region in the second site. For each of the at least part of the plurality of second regions, a distance between the second region after arrangement and the first region is positively correlated with an association degree between the second region and the first region.

In some examples, in a case that the first site and the second site are of a same type, the first region includes an entrance and exit region, and the plurality of second regions include store regions. Or, in a case that the first site and the second site are of different types, the first region includes an entrance and exit region, and the plurality of second regions include store regions, or the first region and the plurality of second regions include store regions.

In some examples, the arrangement module 53 is further configured to: after performing region arrangement on the second site, acquire association degree data between two adjacent regions after arrangement; and determine an arrangement position of a temporary booth according to types of the two adjacent regions and the association degree data between the two adjacent regions.

In some examples, in a case that the first site and the second site are of the same type, the first site includes a plurality of first regions, and the plurality of first regions include entrance and exit regions, for each of the plurality of first regions, the region arrangement analysis result includes a sum of association degree data between the first region and each of the plurality of second regions. The arrangement module 53 is configured to: according to ranking of sums of association degree data, determine to open at least part of entrances and exits in the plurality of first regions, and close entrances and exits other than the at least part of entrances and exits in the plurality of first regions. The sum of the association degree data for the first region corresponding to an opened entrance and exit is greater than or equal to the sum of the association degree data for the first region corresponding to a closed entrance and exit.

In some examples, the region arrangement analysis result includes target association degree data in which association degree data is greater than a predetermined threshold. The apparatus further includes: a promotion module configured to place at least part of commodities sold in the second region corresponding to the target association degree data in the first region for sale; and/or place a commodity with the same type as the at least part of the commodities sold in the second region corresponding to the target association degree data in the first region for sale; and/or push promotion data of the second region corresponding to the target association degree data through a promotion device deployed in the first region.

In an example, the promotion module includes a first promotion module configured to place at least part of commodities sold in the second region corresponding to the target association degree data in the first region for sale.

In an example, the promotion module includes a second promotion module configured to place a commodity with the same type as the at least part of the commodities sold in the second region corresponding to the target association degree data in the first region for sale.

In an example, the promotion module includes a third promotion module configured to push promotion data of the second region corresponding to the target association degree data through a promotion device deployed in the first region.

It should be understood by those skilled in the art that the implementation function of each processing module in the region arrangement apparatus shown in FIG. 5 may be understood with reference to the relevant description of the foregoing region arrangement methods. It should be understood by those skilled in the art that the functions of each processing unit in the region arrangement apparatus shown in FIG. 5 may be implemented by a program running on a processor, and may also be implemented by a specific logic circuit.

In practice, the specific structures of the acquisition module 51, the analyzing module 52, the arrangement module 53 and promotion module (including at least one of the first promotion module, the second promotion module or the third promotion module) may all correspond to a processor. The specific structure of the processor may be an electronic component or a set of electronic components having a processing function such as a Central Processing Unit (CPU), a Micro Controller Unit (MCU), a Digital Signal Processing (DSP), or a Programmable Logic Controller (PLC). The processor includes an executable code, where the executable code is stored in a storage medium, and the processor may be coupled to the storage medium through a communication interface such as a bus, and when a specific corresponding function of each unit is executed, the executable code is read from the storage medium and run. The part of the storage medium for storing the executable code is preferably a non-transitory storage medium.

The region arrangement apparatus provided by examples of the present disclosure can perform reasonable layout on the regions in the second site based on the association degree data between regions in the first site, thereby increasing the number of customers and sales revenue.

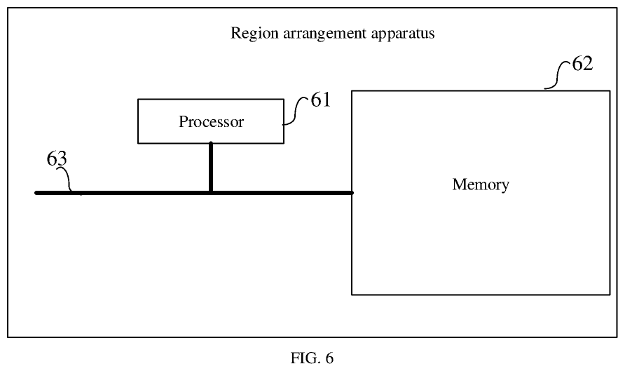

Examples of the present disclosure further provide a region arrangement apparatus. FIG. 6 is a schematic diagram of a hardware structure of a region arrangement apparatus provided by examples of the present disclosure. As shown in FIG. 6, the apparatus includes a memory 62, a processor 61 and a computer program stored in the memory 62 and executable on the processor 61, where when the computer program is executed by the processor 61, the region arrangement method provided by any one of the foregoing technical solutions is implemented.

It is understood that the various components in the region arrangement apparatus may be coupled together by a bus system 63. It will be appreciated that the bus system 63 is used to implement connection communication between these components. The bus system 63 includes a power bus, a control bus, and a status signal bus in addition to the data bus. However, for clarity of illustration, various buses are denoted as bus system 63 in FIG. 6.

It can be understood that the memory 62 may be a volatile memory or a non-volatile memory, and may also include both volatile memory and non-volatile memory. The non-volatile memory may be a read only memory (ROM), a programmable read-only memory (PROM), an erasable programmable read-only memory (EPROM), an electrically erasable programmable read-only memory (EEPROM), a ferromagnetic random access memory (FRAM), a Flash Memory, a magnetic surface memory, a Compact Disc, or a Compact Disc Read-Only Memory (CD-ROM). The magnetic surface memory may include a magnetic disk memory or a magnetic tape memory. The volatile memory may be a Random Access Memory (RAM), which functions as an external cache. By way of example and not by way of limitation, many forms of RAM are available. For example, Static Random Access Memory (SRAM), Synchronous Static Random Access Memory (SSRAM), Dynamic Random Access Memory (DRAM), Synchronous Dynamic Random Access Memory (SDRAM), Double Data Rate Synchronous Dynamic Random Access Memory (DDRSDRAM), Enhanced Synchronous Dynamic Random Access Memory (ESDRAM), SyncLink Dynamic Random Access Memory (SLDRAM) and Direct Rambus Random Access Memory (DRRAM) are available. The memory 62 described in the examples of the present disclosure is intended to include, but not limited to, these and any other suitable type of memory.

The method disclosed in the examples of the present disclosure may be applied to the processor 61 or implemented by the processor 61. The processor 61 may be an integrated circuit chip having a processing capability of a signal. In the implementation process, each step of the above method may be completed by an integrated logic circuit of hardware in the processor 61 or an instruction in the form of software. The processor 61 may include a general-purpose processor, a Digital Signal Processor (DSP), or other programmable logic device, a discrete gate or transistor logic device, a discrete hardware component, or the like. The processor 61 may implement or execute various methods, steps, and logical block diagrams disclosed in examples of the present disclosure. The general-purpose processor may include a microprocessor or any conventional processor or the like. In conjunction with the steps of the method disclosed in the examples of the present disclosure, it may be directly embodied that the execution is completed by the hardware decoding processor or a combination of the hardware in the decoding processor and software modules. The software module may be located in a storage medium, the storage medium is located in the memory 62, and the processor 61 reads information in the memory 62, and completes the steps of the foregoing methods in conjunction with hardware thereof.

In an exemplary example, the region arrangement apparatus may be implemented by one or more of application specific integrated circuit (ASIC), DSP, programmable logic devices (PLD), complex programmable logic device (CPLD), FPGA, general purpose processor, controller, MCU, microprocessor, or other electronic component for performing the foregoing methods.

Examples of the present disclosure further provide a computer storage medium storing computer executable instructions. The computer executable instructions are configured to execute the region arrangement method described in the foregoing examples. That is, after the computer executable instructions are executed by the processor, the region arrangement method provided by any one of the foregoing technical solutions can be implemented.

It should be understood by those skilled in the art that the functions of each program in the computer storage medium provided by the examples of the present disclosure can be understood with reference to the relevant description of the region arrangement method described in the foregoing examples.

Examples of the present disclosure further provide a computer program. The computer program causes a computer to perform region arrangement methods described in examples of the present disclosure.

In several examples provided by the present disclosure, it should be understood that the disclosed apparatuses and methods may be implemented in other ways. The apparatus examples described above are merely schematic, for example, the division of the units is merely a logical function division, and there may be another division manner in actual implementation, for example, a plurality of units or components may be combined, or may be integrated into another system, or some features may be ignored or not performed. Moreover, the coupling, or direct coupling, or communication connection between the components shown or discussed may be through some interfaces. Indirect coupling or communication connection of devices or units may be electrical, mechanical, or other forms.

The units described as separate components may or may not be physically separate, and the components displayed as units may or may not be physical units. The components displayed as units may be located in one place or distributed to a plurality of network units. Some or all of the units may be selected according to actual needs to achieve the purpose of the examples of the present disclosure.

In addition, all the functional units in the examples of the present disclosure may be integrated into one processing unit, or each functional unit separately serves as one unit, or two or more functional units may be integrated into one unit. The integrated units may be implemented in the form of hardware or in the form of hardware and software function units.

Persons of ordinary skill in the art may understand that all or part of the steps of the foregoing method examples may be implemented by a program instructing relevant hardware. The foregoing program may be stored in a computer readable storage medium. When the program is executed, the steps of the foregoing method examples are executed. The foregoing storage medium includes various media that can store program codes, such as a removable storage device, a ROM, a RAM, a magnetic disk, or an optical disk.

Alternatively, if the integrated unit in the present disclosure is implemented in the form of a software function module and sold or used as an independent product, the integrated unit may also be stored in a computer readable storage medium. Based on such understanding, the technical solutions provided by the examples of the present disclosure may be embodied in the form of a software product in nature or part of the technical solutions that make a contribution to the prior art may be embodied in the form of a software product. The computer software product is stored in a storage medium and includes instructions to cause a computer device (which may be a personal computer, a server, or a network device, etc.) to perform all or part of the methods described in various examples of the present disclosure. The foregoing storage medium includes various media that can store program codes, such as a removable storage device, a ROM, a RAM, a magnetic disk, or an optical disk.

The foregoing description is merely a specific embodiment of the present disclosure, but the scope of protection of the present disclosure is not limited thereto, and any variation or replacement readily conceivable by a person skilled in the art within the technical scope disclosed in the present disclosure should belong to the scope of protection of the present disclosure. Therefore, the scope of protection of the present disclosure should be based on the scope of protection of said claims.

1. A region arrangement method, comprising:
respectively acquiring association degree data between a first region and each of a plurality of second regions, wherein the first region and the plurality of second regions are located in a first site;
obtaining a region arrangement analysis result by analyzing, according to the association degree data, arrangement between the first region and the plurality of second regions in the first site; and
based on the region arrangement analysis result, performing region arrangement on a second site or outputting region arrangement information of the second site.

2. The method according to claim 1, wherein respectively acquiring association degree data between the first region and each of the plurality of second regions comprises:
acquiring a plurality of video images of the first site within a predetermined time range;
performing pedestrian identification processing on the plurality of video images to obtain, based on the identification result, a customer counting result for each of the first region and the plurality of second regions; and
determining, based on customer counting results, association degree data between the first region and each of the plurality of second regions, respectively.

3. The method according to claim 2, wherein the region arrangement analysis result comprises ranking of the association degree data.

4. The method according to claim 3, wherein performing region arrangement on the second site based on the region arrangement analysis result comprises:
arranging at least part of the plurality of second regions on two sides of the first region according to the ranking of the association degree data and a position of the first region in the second site.

5. The method according to claim 4, wherein for each of the at least part of the plurality of second regions, a distance between the second region after arrangement and the first region is positively correlated with an association degree between the second region and the first region.

6. The method according to claim 1, wherein in a case that the first site and the second site are of a same type, the first region comprises an entrance and exit region, and the plurality of second regions comprise store regions.

7. The method according to claim 1, wherein in a case that the first site and the second site are of different types, the first region comprises an entrance and exit region, and the plurality of second regions comprise store regions, or the first region and the plurality of second regions comprise store regions.

8. The method according to claim 1, wherein after performing region arrangement on the second site, the method further comprises:
acquiring association degree data between two adjacent regions after arrangement; and
determining an arrangement position of a temporary booth according to types of the two adjacent regions and association degree data between the two adjacent regions.

9. The method according to claim 1, wherein in a case that the first site and the second site are of the same type, the first site comprises a plurality of first regions, and the plurality of first regions comprise entrance and exit regions,
for each of the plurality of first regions, the region arrangement analysis result comprises a sum of association degree data between the first region and each of the plurality of second regions.

10. The method according to claim 9, wherein performing region arrangement on the second site based on the region arrangement analysis result comprises:
according to ranking of sums of association degree data, determining to open at least part of entrances and exits in the plurality of first regions, and close entrances and exits other than the at least part of entrances and exits in the plurality of first regions.

11. The method according to claim 10, wherein the sum of the association degree data for the first region corresponding to an opened entrance and exit is greater than or equal to the sum of the association degree data for the first region corresponding to a closed entrance and exit.

12. The method according to claim 1, wherein the region arrangement analysis result comprises target association degree data in which association degree data is greater than a predetermined threshold.

13. The method according to claim 12, further comprising:
placing at least part of commodities sold in the second region corresponding to the target association degree data in the first region for sale.

14. The method according to claim 12, further comprising:
placing a commodity with the same type as the at least part of the commodities sold in the second region corresponding to the target association degree data in the first region for sale.

15. The method according to claim 12, further comprising:
pushing promotion data of the second region corresponding to the target association degree data through a promotion device deployed in the first region.

16. A region arrangement apparatus, comprising: a memory, a processor, and a computer program stored on the memory and executable on the processor;
wherein when the computer program is executed by the processor, the processor is caused to execute operations comprising:
respectively acquiring association degree data between a first region and each of a plurality of second regions, wherein the first region and the plurality of second regions are located in a first site;
obtaining a region arrangement analysis result by analyzing, according to the association degree data, arrangement between the first region and the plurality of second regions in the first site; and
based on the region arrangement analysis result, performing region arrangement on a second site or outputting region arrangement information of the second site.

17. The apparatus according to claim 16, wherein respectively acquiring association degree data between the first region and each of the plurality of second regions comprises:
acquiring a plurality of video images of the first site within a predetermined time range;
performing pedestrian identification processing on the plurality of video images to obtain, based on the identification result, a customer counting result for each of the first region and the plurality of second regions; and
determining, based on customer counting results, association degree data between the first region and each of the plurality of second regions, respectively.

18. The apparatus according to claim 17, wherein the region arrangement analysis result comprises ranking of the association degree data.

19. The apparatus according to claim 18, wherein performing region arrangement on the second site based on the region arrangement analysis result comprises:
arranging at least part of the plurality of second regions on two sides of the first region according to the ranking of the association degree data and a position of the first region in the second site.

20. A non-transitory computer storage medium storing a computer program, when the computer program is executed by a processor, the processor is caused to perform operations comprising:
respectively acquiring association degree data between a first region and each of a plurality of second regions, wherein the first region and the plurality of second regions are located in a first site;
obtaining a region arrangement analysis result by analyzing, according to the association degree data, arrangement between the first region and the plurality of second regions in the first site; and
based on the region arrangement analysis result, performing region arrangement on a second site or outputting region arrangement information of the second site.
